(19) United States
(12) Patent Application Publication
(10) Pub. No.: US 2021/0078705 A1
(43) Pub. Date: Mar. 18, 2021

(54) CANARD ROOT POSITIONED AT THE NOSE TIP AND BEYOND THE NOSE TIP OF AIRCRAFT AND SPACECRAFT RELATED VEHICLES OR PROPELLED/PROJECTILE OBJECTS TO REDUCE DRAG

(71) Applicant: Taylor DiAnte' Brown, Jackson, MS (US)

(72) Inventor: Taylor DiAnte' Brown, Jackson, MS (US)

(21) Appl. No.: 16/571,877

(22) Filed: Sep. 16, 2019

(51) Int. Cl. B64C 39/12; B64C 5/04

(52) U.S. Cl. CPC B64C 39/12; B64C 5/04

(57) ABSTRACT

The canards of a vehicle or object generally come out of the body on the nose. When the canards are positioned at the nose tip or beyond the nose tip of the body of a vehicle or object, it becomes more streamlined. By becoming more streamlined, the vehicle or object can achieve better performances in drag reduction and stability.

### BACKGROUND OF THE INVENTION

Birds have always been aerodynamically efficient. Through examining the shape of bird wings, we have been able to learn how they maintain flight. In ways, we have created our own versions of these wings so we can achieve flight with our aircrafts. Besides the regular type of wing, we have also created smaller ones referred to as canards. The main forces that act on an aircraft are lift and drag. Lift sustains an aircraft in the air while drag pushes against the aircraft as a consequence of the aircraft moving forward. There have been different methodologies in reducing drag and increasing lift on aircraft by changing the shape of the wings and canards. However, in the case of canards, forces on an aircraft can be affected by also changing the location of them.

This invention is to be applied in the field of fluid mechanics. This invention targets making a vehicle or object more streamlined and therefore reducing drag and increasing stability. An aircraft produces less drag if the canard's root leading edge is at the nose tip or beyond the nose tip of the aircraft. The less drag an aircraft produces, the more stable it becomes. As the canard's root leading edge moves further away after the nose of the aircraft, the aircraft can produce more drag and becomes less stable depending on the shape of the nose.

### BRIEF SUMMARY OF THE INVENTION

Most vehicles and objects that consist of canards, have them being positioned on the nose. However, this invention promotes the leading edge of the canard root being moved to the nose tip and beyond the nose tip to become more streamlined. By moving the canard's root leading edge to the front of the vehicle or object, it reduces drag.

### BRIEF DESCRIPTION OF THE DRAWINGS

FIG. 1A displays the front view of the aircraft. FIG. 1A displays the number 1 pointing to one out of two canards on the aircraft. The number 2 is pointing to the area where a canard's root leading edge originate from, which is at the nose tip of the aircraft.

FIG. 1B displays the top view of the aircraft. FIG. 1B displays the number 3 attached to the surface of a canard. The number 3 in FIG. 1B denotes the top view of the canard that is denoted as number 1 in FIG. 1A. The number 4 is pointing to the area where the leading edge of the canard root is located, which is at the nose tip of the aircraft. The area denoted as number 4 is the top view of the area denoted as number 2 in FIG. 1A. The curve line with two slanted lines intersecting its middle on the left wing or left side of the figure denotes the end point of interest of the aircraft.

FIG. 1C displays the side view of the aircraft. FIG. 1C displays the number 5 pointing to a canard. This canard is the side view of the canard that is denoted in FIG. 1A and FIG. 1B as number 1 and number 3 respectively. The number 6 is pointing to the area where the leading edge of the canard root is located, which is at the nose tip of the aircraft. The area denoted as number 6 is the side view of the areas denoted as number 2 and number 4 in FIG. 1A and FIG. 1B respectively.

FIG. 2A displays the front view of the aircraft. FIG. 2A displays the number 7 pointing to one out of two canards on the aircraft. The number 8 is pointing to the point where both canards' root leading edge meet, which is beyond the nose tip of the aircraft.

FIG. 2B displays the top view of the aircraft. FIG. 2B displays the number 9 attached to the surface of a canard. The number 9 in FIG. 2B denotes the top view of the canard that is denoted as number 7 in FIG. 2A. The number 10 in FIG. 2B denotes the top view of the point where both canards meet that is denoted as number 8 in FIG. 2A. The number 10 is pointing to the point where both canards' root leading edge meet, which is beyond the nose tip of the aircraft. The curve line with two slanted lines intersecting its middle on the left wing or left side of the figure denotes the end point of interest of the aircraft.

FIG. 2C displays the side view of the aircraft. FIG. 2C displays the number 11 pointing to a canard. This canard is the side view of the canard that is denoted in FIG. 2A and FIG. 2B as number 7 and number 9 respectively. The number 12 is pointing to the point where the leading edge of both canards' root meet, which is beyond the nose tip of the aircraft. The point denoted as number 12 is the side view of the points denoted as number 8 and number 10 in FIG. 2A and FIG. 2B respectively.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

There are multiple types of vehicles and objects that can utilize this invention such as: an aircraft, spacecraft, propelled object, and projectile object. The following definitions of an aircraft, spacecraft, propelled object, and projectile object are simply defined, and are not limited to these definitions. An aircraft is any vehicle made to fly within the Earth's atmosphere. A spacecraft is any vehicle made to exit the Earth's atmosphere. A propelled object is any object that has a propulsion system to propel the object in a designated direction. A projectile object is any object that has the capability of being launched from a person's hand or a platform.

The canards on a vehicle or object sustain it in flight. Depending on how the canards are shaped can affect how streamlined a vehicle or object is while also affecting lift and drag. Streamlined is defined as but not limited to, a shape of a vehicle or object that is resistant to drag. Lift is defined as but not limited to, the force that sustains the vehicle or object in air. Drag is the opposing force operating on the surface of a vehicle or object while it is in travel. This invention entails changing the location of where the canard's root leading edge is and/or where the canard root come out of the body of the vehicle or object to make it more streamlined. “Come out of the body” or “coming out of the body” describes the location where the root or base of the canards is connected to the main body of the vehicle or object. The root is defined as but not limited to, the part that connects to the body of a vehicle or object.

For example, in using the older canard configurations of an aircraft, the canards come out of the body in the front region. “Older” describes the root of the canard configurations coming out of the front region, but not having its root leading edge at the nose tip and/or the root leading edge beyond the nose tip. The canard's root leading edge is the foremost part of the canard that is closest to the axis of symmetry and/or the axis corresponding to the center of rotation of the vehicle's or object's main body and/or fuselage. The nose tip is defined as but not limited to, the foremost part of the fuselage and/or main body. “Beyond” describes the canard's root leading edge being in front of the nose tip of a vehicle or object, and/or describes the canard's root leading edge being the foremost part of the fuselage. In applying the invention, if the canard's root come out of the body at the nose tip, it can reduce drag. Also, if the canard's root leading edge is beyond the nose tip, it can reduce drag.

It is important to note that there are some airplanes that have their canards' root at the nose tip. However, this may be because of other reasons instead of specifically to become more streamlined and reduce drag. If a vehicle or object reduces drag and/or becomes more stable as a result of becoming streamlined, then this describes the invention. This invention describes all canard configuration designs that have their root leading edge located at the nose tip and/or root leading edge beyond the nose tip to become more streamlined and reduce drag.

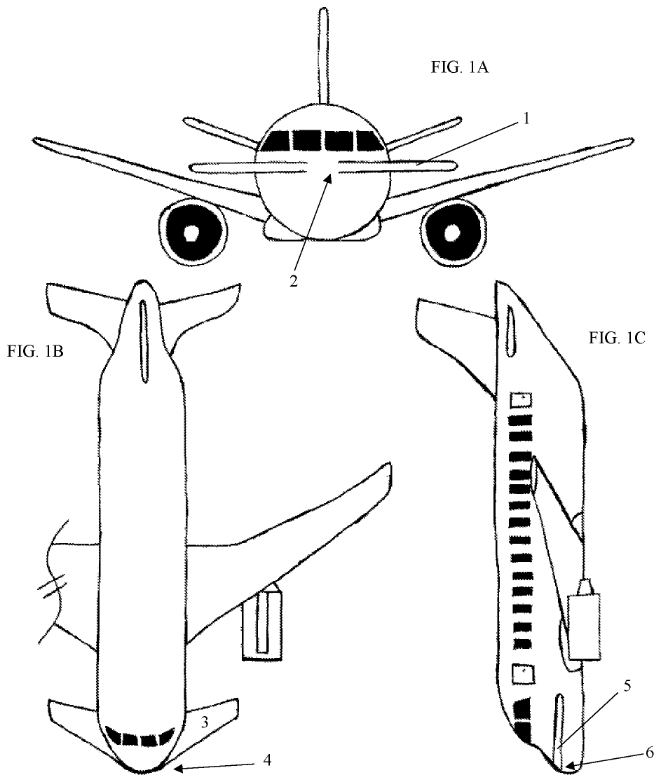

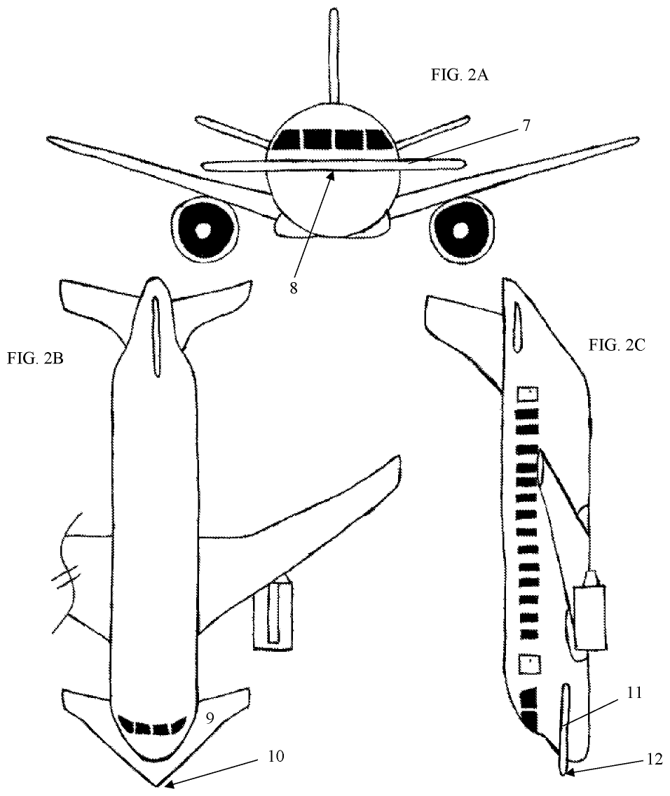

FIGS. 1A, 1B, and 1C display examples of the leading edge of the canard root being located at the nose tip of an aircraft. FIGS. 2A, 2B, and 2C display examples of the leading edge of two canard roots combined and are located beyond the nose tip of an aircraft. It is presumed that these figures do not limit the scope or usefulness of the invention. For example, there can be different vehicles or objects with different canard shapes and different number of canards.

FIG. 1A displays the front view of the aircraft. FIG. 1A displays the number 1 pointing to one out of two canards on the aircraft. The number 2 is pointing to the area where a canard's root leading edge originate from, which is at the nose tip of the aircraft. FIG. 1B displays the top view of the aircraft. FIG. 1B displays the number 3 attached to the surface of a canard. The number 3 in FIG. 1B denotes the top view of the canard that is denoted as number 1 in FIG. 1A. The number 4 is pointing to the area where the leading edge of the canard root is located, which is at the nose tip of the aircraft. The area denoted as number 4 is the top view of the area denoted as number 2 in FIG. 1A. The curve line with two slanted lines intersecting its middle on the left wing or left side of the figure denotes the end point of interest of the aircraft. FIG. 1C displays the side view of the aircraft. FIG. 1C displays the number 5 pointing to a canard. This canard is the side view of the canard that is denoted in FIG. 1A and FIG. 1B as number 1 and number 3 respectively. The number 6 is pointing to the area where the leading edge of the canard root is located, which is at the nose tip of the aircraft. The area denoted as number 6 is the side view of the areas denoted as number 2 and number 4 in FIG. 1A and FIG. 1B respectively.

FIG. 2A displays the front view of the aircraft. FIG. 2A displays the number 7 pointing to one out of two canards on the aircraft. The number 8 is pointing to the point where both canards' root leading edge meet, which is beyond the nose tip of the aircraft. FIG. 2B displays the top view of the aircraft. FIG. 2B displays the number 9 attached to the surface of a canard. The number 9 in FIG. 2B denotes the top view of the canard that is denoted as number 7 in FIG. 2A. The number 10 in FIG. 2B denotes the top view of the point where both canards meet that is denoted as number 8 in FIG. 2A. The number 10 is pointing to the point where both canards' root leading edge meet, which is beyond the nose tip of the aircraft. The curve line with two slanted lines intersecting its middle on the left wing or left side of the figure denotes the end point of interest of the aircraft. FIG. 2C displays the side view of the aircraft. FIG. 2C displays the number 11 pointing to a canard. This canard is the side view of the canard that is denoted in FIG. 2A and FIG. 2B as number 7 and number 9 respectively. The number 12 is pointing to the point where the leading edge of both canards' root meet, which is beyond the nose tip of the aircraft. The point denoted as number 12 is the side view of the points denoted as number 8 and number 10 in FIG. 2A and FIG. 2B respectively. It is presumed that the processes, manufacturability, and assembly of these canard configurations on the body of the aircraft, spacecraft, propelled object, or projectile object should follow the same or similar guidelines in how the older designs of canard configurations for vehicles and objects are made.

1. An aircraft's canard comprising of a root chord originating from an aircraft's fuselage front.

2. The root chord originating from the aircraft's fuselage front of claim 1, comprising of a leading edge in front of an aircraft's fuselage leading edge.
